(19) United States
(12) Patent Application Publication
(10) Pub. No.: US 2004/0107206 A1
(43) Pub. Date: Jun. 3, 2004

(54) Automated retrieval of data from remote location and database synchronization

(76) Inventor: Timothy P. Heikell, Issaquah, WA (US)

Correspondence Address: GRAYBEAL, JACKSON, HALEY LLP, 155 - 108TH AVENUE NE, SUITE 350, BELLEVUE, WA, 98004-5901, US

(21) Appl. No.: 10/417,813

(22) Filed: Apr. 16, 2003

Related U.S. Application Data
(60) Provisional application No. 60/373,411, filed on Apr. 16, 2002.

(51) Int. Cl. G06F 17/00

(52) U.S. Cl. 707/102

(57) ABSTRACT

Methods for automated transformation of data residing on a storage device and delivery via SMTP to a physically remote data storage device are disclosed. In one method, database information from a first data storage device is obtained and an email-based file created having the polled information present therein. The email-based file is sent to a second data storage device, which is operable to receive the email-based file. The email-based file is then retrieved and the information parsed, where after the parsed information is preferably stored in the second data storage device. In another method, a database containing data residing in a first storage device is polled. The polled data is compiled into a formatted data file, such as an HTML page, where after it is submitted to a second storage device. An application operative on the second storage device parses the data and stores the parsed data. Reverse operations of the foregoing are also provided.

### FIELD OF THE INVENTION

The present invention pertains to a process for taking data submitted to a server linked to a wide area network, such as a commercial web site, and record it into a database that is completely isolated from the wide area network using formatted email messages.

### BACKGROUND OF THE INVENTION

As the world of online or e-commerce matures, more and more goods and services vendors and businesses are making their wares and services available online to potential customers. And while the prices for computer hardware and network connectivity continue to decrease, there are still formidable barriers to entry for small businesses wishing to exploit online business opportunities.

A common scenario is that a business' online presence is carried out by a hosting entity. The hosting entity provides both virtual space on a web server and connectivity to the Internet so that consumers may evaluate and potentially purchase that which the business wishes to sell. Thus, the business or vendor merely supplies the necessary computer program applications and product/service data to the hosting entity, and periodically accesses the web site to determine if sales have taken place that need fulfillment.

In the above-described scenario, however, the business must manually access the web site to make this determination. To overcome this deficiency, it is of course possible to have the business host its own web site, whereby the data would reside locally. However, in many cases, the costs and overhead for such an activity are too great as compared to the returns. It is therefore desirable to have a means for automatically retrieving the remotely stored order data, and do so in a manner that preferably does not involve avoidable security risks.

Traditionally, to have real time entries recorded into a local database required that the local database reside on a server that has a direct connection to the Internet with a static IP address and was protected by a firewall. Firewalls are not impervious to computer hackers. Systems such as these are expensive to build and maintain and are therefore cost prohibitive to small companies or even large companies if they wanted such a system at every remote office.

### SUMMARY OF THE INVENTION

The invention is directed to improved methods for transferring data information from a first data storage device such as a computer with memory operatively linked to a wide area network (WAN) such as the Internet to a second data storage device such as a computer with memory that may not be continuously linked to the WAN, and optionally vice versa. Summarily stated, a first method comprises polling form-based or database information from the first data storage device and creating an email-based file having the polled information present therein. The email-based file having the information therein is then sent via the WAN to the second data storage device which is adapted to receive the email-based file. The email-based file is then retrieved and the information parsed. Finally, the parsed information is stored in the second data storage device, which is remote from the first device. The invention is also directed to reverse operations, i.e., data can be obtained from the second data storage device and delivered to the first data storage device.

A second method comprises querying a table containing data residing in the first storage device and polling the first storage device for the data. The polled data is then compiled into a formatted data file, such as an HTML page in a preferred embodiment; and submitted file to the second storage device. An application operative on the second storage device parses the data and stores the parsed data, which is physical remote from the first storage device.

Concerning the first method and in a preferred embodiment, the form-based data is polled from the first data storage device, which is a first server, by a custom application that is resident thereon. The information is then formatted in a predefined manner such as tab or comma separated data, or name-value pairs. Preferably, a validation key is also included in the data for subsequent use. The formatted information is then placed into the body of an email file having a predetermined destination address (username@secondleveldomain.topleveldomain), and delivered to a second data storage device, which is a second server, running a computer application configured to receive the email file. The computer application may be physically resident on the first server, or may be resident on a second server physically remote from the first server but is operatively connected thereto by means of a Local Area Network (LAN) or WAN.

The email file is then preferably retrieved from the computer application adapted to receive the email file by a client computer having an email retrieval computer application active thereon. The client computer may be linked to the first server or second server via the LAN or WAN, and may have a dedicated connectivity with respect thereto, or may be intermittently connectable to the WAN, such as by dialup means. Once the email file has been retrieved, a parsing routine is then performed on the retrieved email to acquire the data present therein where after the data is stored in computer memory for subsequent use.

If security issues are of concern, it is preferably that the first server, which is accessible to WAN or Internet users, also have the requisite email file creation, sending and receiving capabilities, or have only LAN connectivity to devices or servers having such capabilities. In this manner, the form-based information is only distributed “locally” either internal to the first server or within the LAN to which the first server is connected. No information is distributed via a WAN or Internet. In a preferred embodiment, remote retrieval of the email file is accomplished by means of a request sent across a network to the second server having an IP address corresponding to the URL of the email address. There, an email application running a POP application or the like isolates the email by username.

### BRIEF DESCRIPTION OF THE DRAWINGS

FIG. 1 is a process flow/functional block diagram illustrating the critical steps for performing the preferred method of the invention;

FIG. 2 is an illustration of an email body comprising form-based data acquired from a remote web server and sent via a STMP mail server application;

FIG. 3 is a process flow/functional block diagram detailing the steps for acquiring the form-based data shown in FIG. 2 and delivering the parsed data to an Intranet database;

FIG. 4 shows representative code for performing the critical functions described herein; and

FIG. 5 shows representative code that would be included on every web page that would be modifying a record that needed to be replicated to another database using either the FTD or FTU operations.

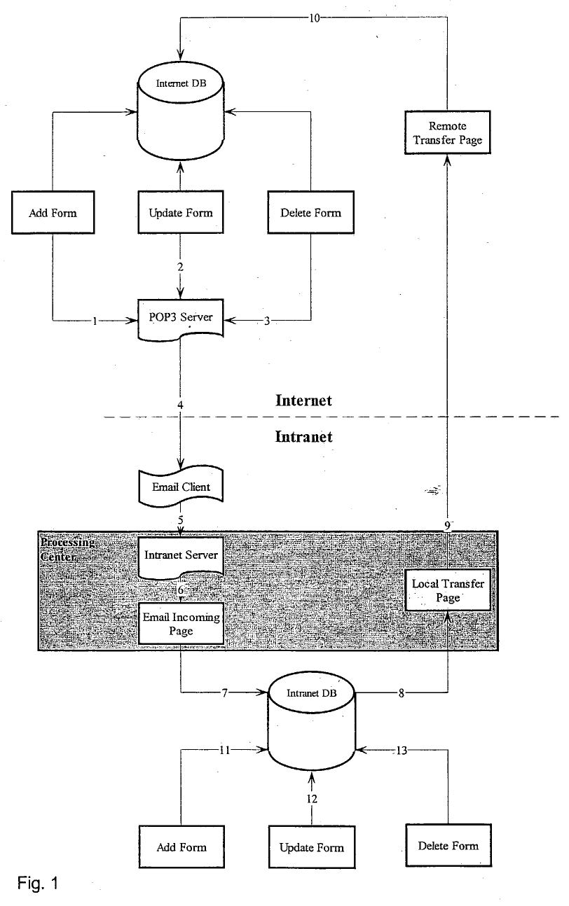

### DETAILED DESCRIPTION OF THE INVENTION

Before describing the preferred embodiment, a basic understanding of the functions and components associated with the preferred embodiment is recommended. Therefore, the following conventions will be used, and the following scenario should be kept in mind as an aid in understanding the invention.

Conventions: ET—Email Transfer; IEP—Incoming Email Page; LTP—Intranet Local Transfer Page; RTP—Internet Remote Transfer Page; WUT Internet and Intranet Web Update Table; FTD—File Transfer Down; FTU—File Transfer Up.

Scenario: A user desirous of purchasing certain goods supplied by a vendor can accomplish this objective by perusing the vendor's web site. After the user has identified the goods for purchase, a web page having an HTML or other form-based screen is displayed for user completion. The form-based data is acquired and stored in a file on the vendor's web server in a format that has been predetermined by the web site owner or vendor. The objective is to transmit the information contained in the stored file to the vendor for order fulfillment.

An embodiment of invention provides several means for transmitting the entered data to the vendor's database for order fulfillment. One means is by ET while another means is by FTD. Each means will be separately described below, but those persons skilled in the art will appreciate the advantages of one over the other depending upon extrinsic factors not germane to the description of the preferred embodiments.

An ET operation is particularly useful if sensitive data is to be sent from an Internet form to an Intranet database. This is so that sensitive data is never written to a database that is available to and potentially vulnerable via an “always on” IP connection. While the described embodiment relates to communications between a WAN and a LAN, an ET can also be used to transfer data and/or actions from one LAN to another LAN.

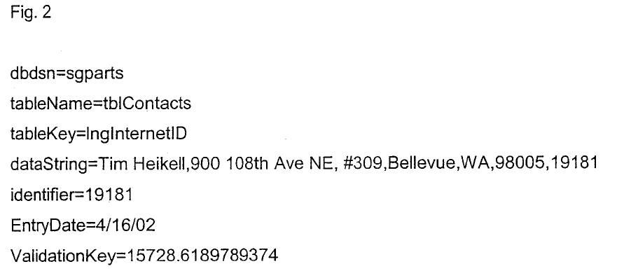

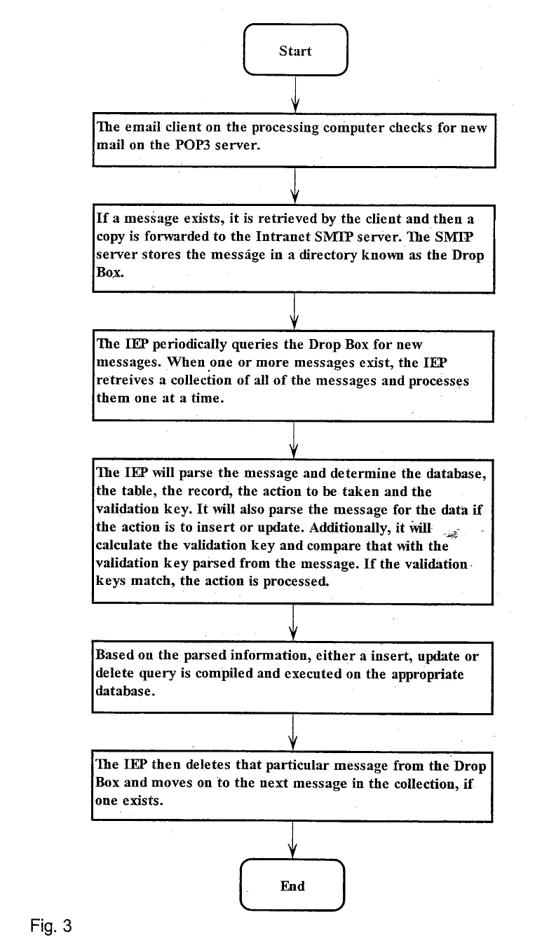

When a form on the Internet is filled out and includes potentially sensitive information, the data from the form is compiled into a formatted email message and optionally. There are many different encryption techniques and which one is used depends on what is compatible with the email software running on the server that is sending the message. The preferred embodiment server uses an email server software that is called Imail and it has a function to encrypt messages using PGP (Pretty Good Protection) encryption. In addition to the customer data, a validation key is included, the purpose of which will be described in more detail below. An example of such an email is shown in FIG. 2. An SMTP service then sends the email to an email address that has been established and configured for transferring this type of data. The email will reside on the POP3 mail server until requested by a Processing Center (e.g., a computer operatively linked to the Internet via SMTP/POP3 services and the Intranet), which is running an email client that will periodically check for new email messages in the mailbox.

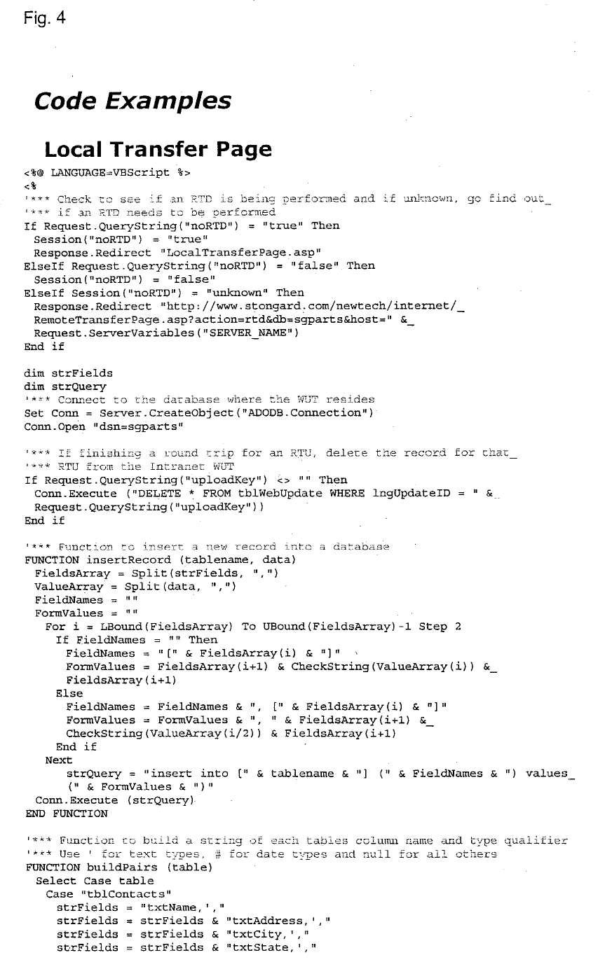

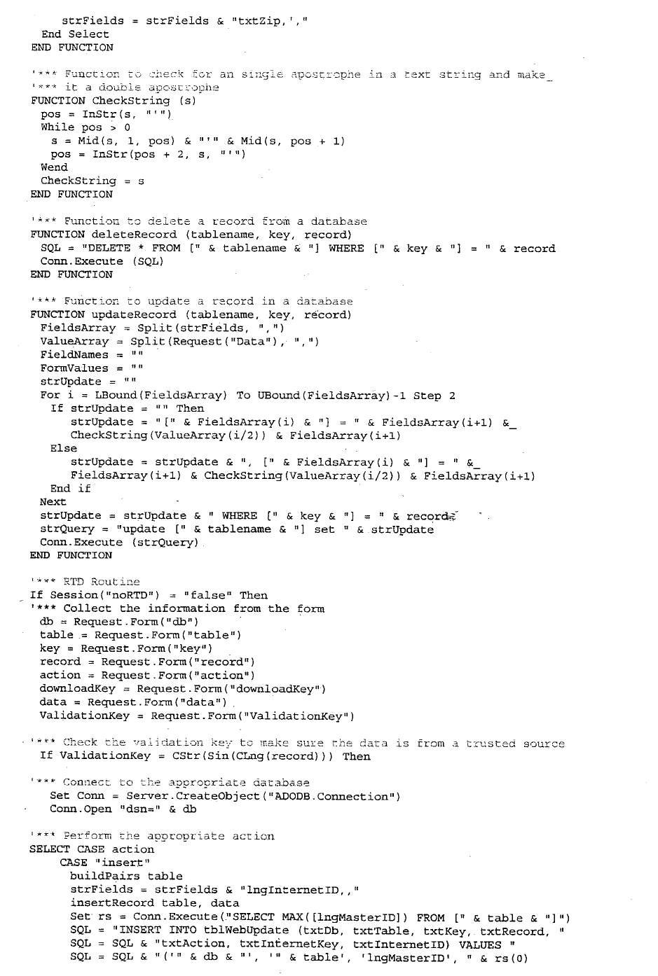

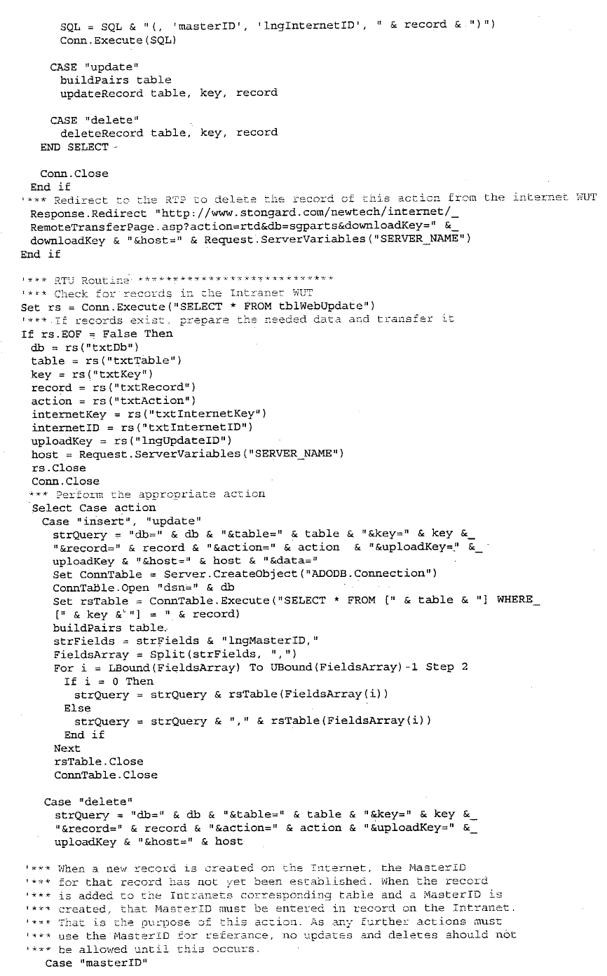

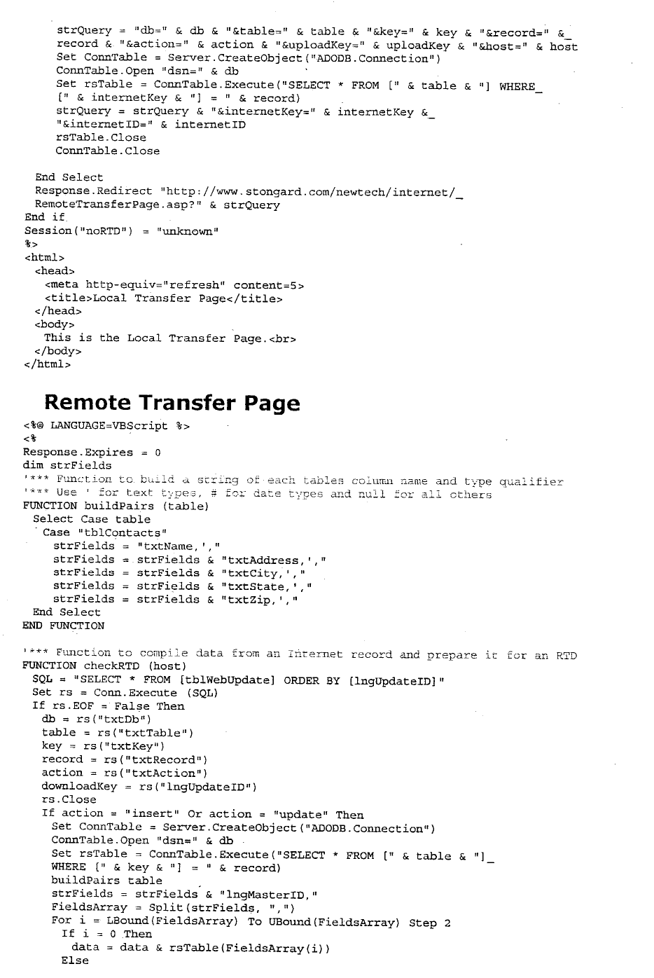

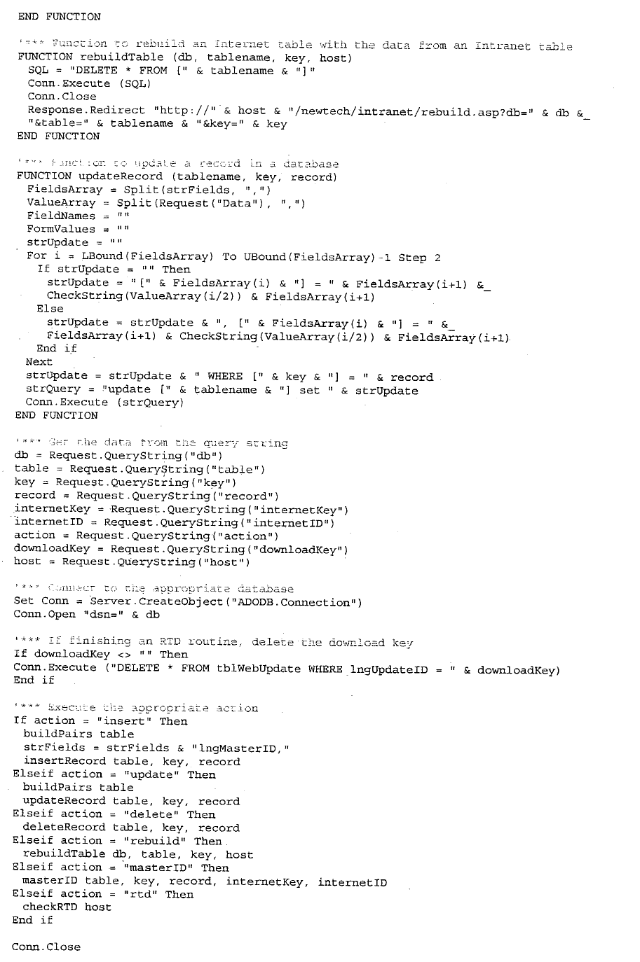

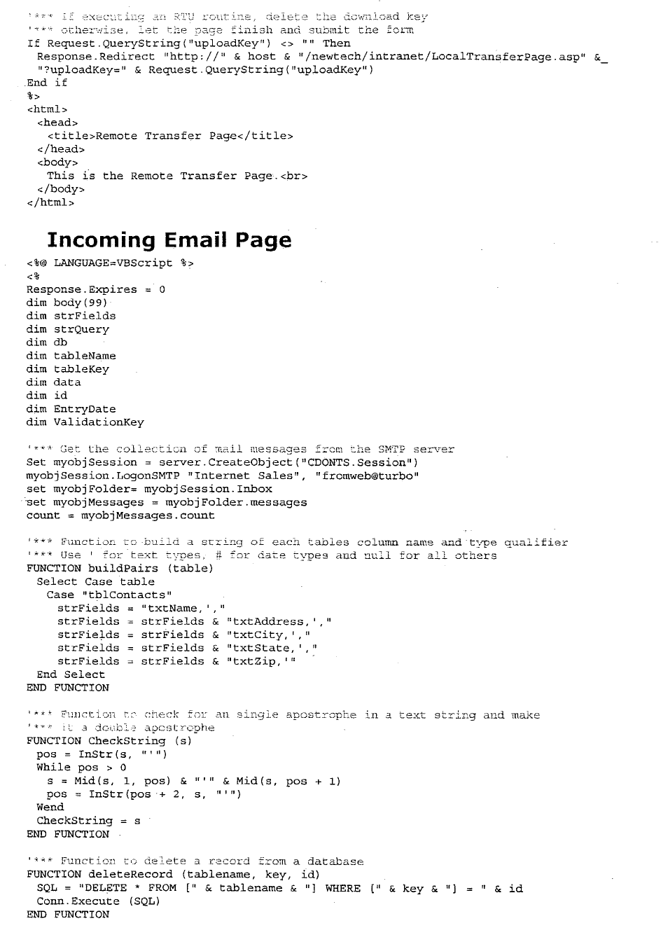

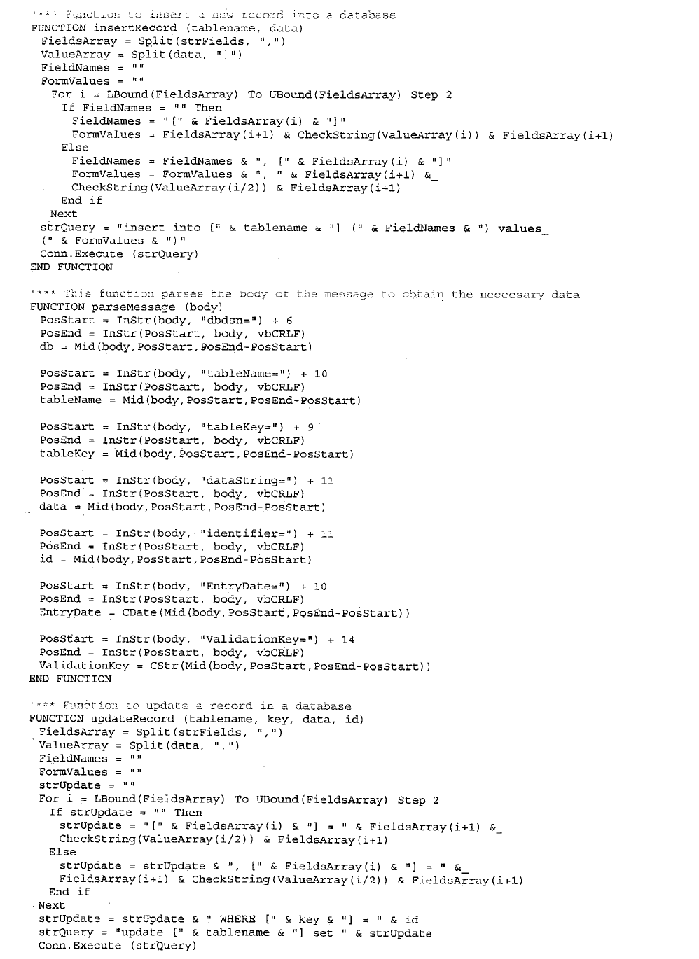

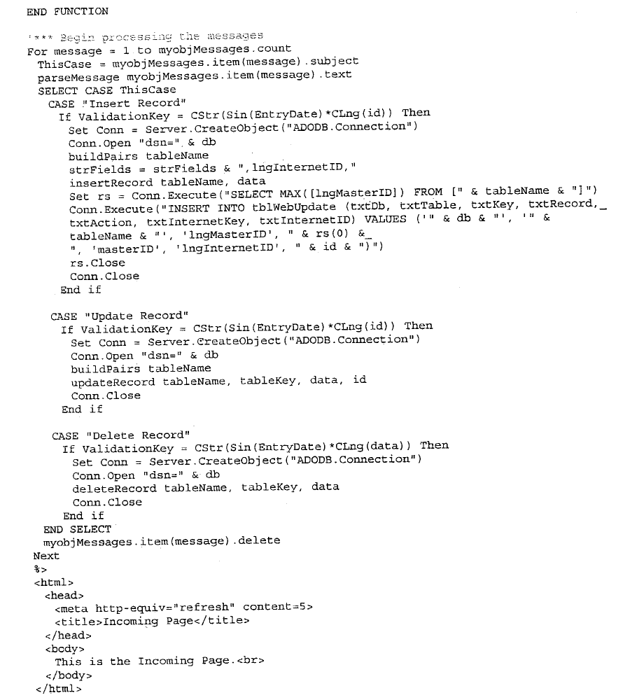

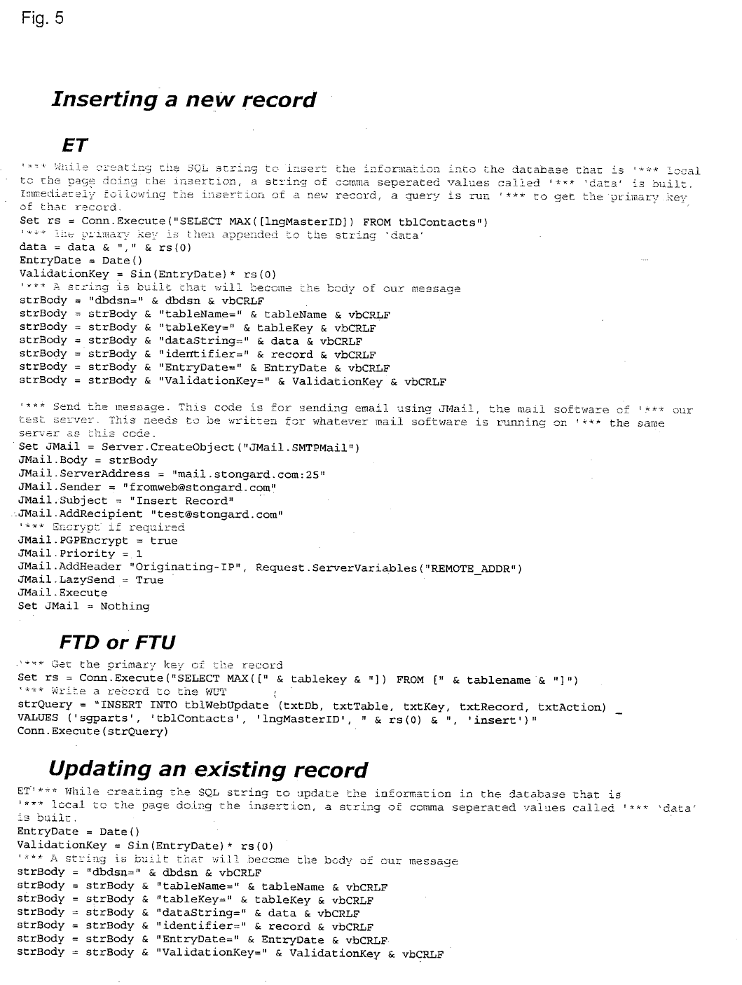

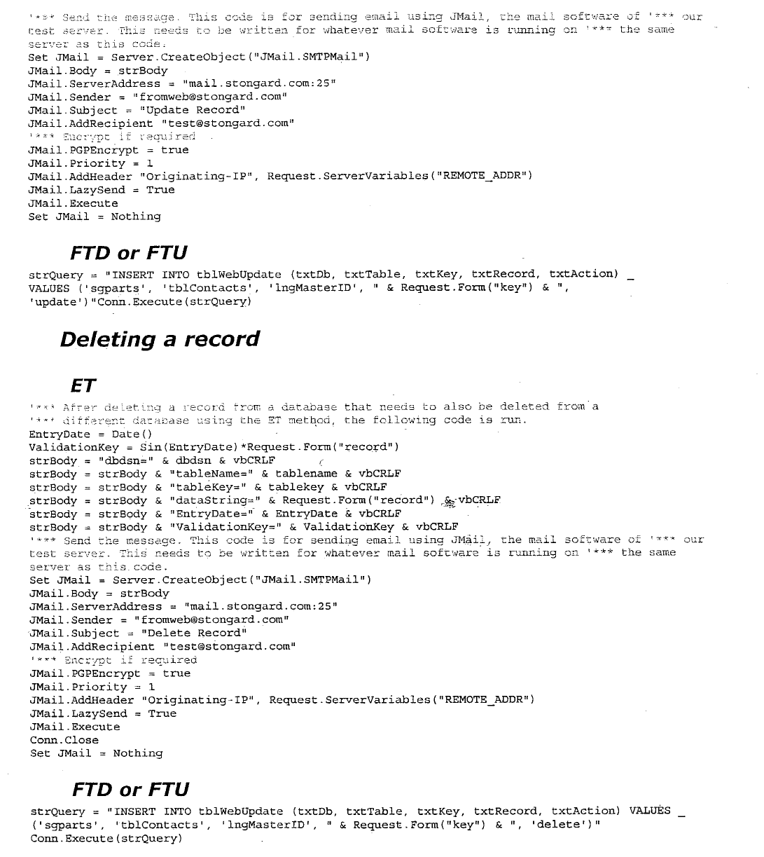

If email exists, the email is retrieved and deleted from the POP3 server by the Processing Center. The Processing Center is also running a web browser, such as Mircrosoft's Internet Explorer 5.0 that is browsing an Intranet web page, namely an Incoming Email Page (IEP), that is set to refresh periodically. When this page refreshes, it checks to see if new email messages have been received. Once a new message is received, the data contained in the email message is parsed. The code that parses the data will determine from the data which database on the Intranet is to be affected. It will also determine which table in that database is to be affected. Lastly, it will determine which action is to be taken on the table. The code may be written in C++ or Perl for Common Gateway Interface (CGI) based form input, or Visual Basic or JAVA script for Active Server Page (ASP) based form input. An example script for carrying out these functions is shown in FIG. 4.

The most typical database related actions are to add a new record (insert), change an existing record (update) or remove an existing record (delete). The email message can be established in many different formats. It may be the required values only, delimited by some character(s) or it may be name/value pairs. The IEP will then take this information, generate a SQL statement and execute it on the appropriate database. Once completed, the IEP then deletes the email message from the drop box, which is a directory where the message is held by the SMTP server.

An FTD can be used in lieu of an ET to move data from the Internet to an Intranet if, for example, the data being transferred does not contain sensitive information. An FTD utilizes a web page that contains the processing code on the Intranet LTP and a web page that contains the processing code on the Internet RTP. An FTU also utilizes a table in a database on the Internet WUT that contains records of data and/or actions that need to be taken on an Intranet database. When there is a need to transfer data and/or an action to the Intranet, a record is written in the WUT. The Processing Center is browsed to the LTP, which periodically redirects to the RTP. The RTP then queries the WUT for records. If no records exist, the browser is simply redirected back to the LTP.

If, however, a record does exist, the RTP gathers the appropriate data to be sent to the Intranet database, enters the values into the fields of a form and automatically submits the form to the LTP. The RTP can also form the data into a query string that is appended to the URL of the LTP and the browser is then redirected to that page. In either case, the Local Transfer Page parses the data, determines the database and table to affect, the action to take and processes the data. The code then redirects the browser back to the RTP on the Internet where the record in the WUT is deleted and the process is repeated.

In addition to transferring new data from a remote location into a local database, the invention also has means for modifying the remote location database based upon information in the local database. To accomplish this objective, an FTU operation is used to transfer data from the Intranet database to the Internet database. An FTU operation utilizes a web page that contains the processing code on the Intranet LTP and a web page that contains the processing code on the Internet RTP. An FTU also utilizes a table in a database on the Intranet WUT that contains records of data and/or actions that need to be taken on an Internet database. When there is a need to transfer data and/or an action to the Internet, a record is written in the WUT. The LTP periodically queries the WUT for records. When a record exists, the LTP gathers the appropriate data to be sent to the Internet database, enters the values into the fields of a form and automatically submits the form to the RTP. Alternatively, it can form the data into a query string that is appended to the URL of the RTP and the browser is then redirected to that page. In either case, the RTP parses the data and determines the database and table to affect, the action to take and processes the data. The code then redirects the browser back to the LTP on the Intranet where the record in the WUT is deleted and the process is repeated.

### EXAMPLES

The following examples illustrate the flexibility of the a preferred embodiment of the invention when performing various functions related to cross-network database communications.

Send Data/Action from an Internet Page to an Intranet Database

Insert/Update

ET Method

A form is filled out on an Internet web page and the data is destined for an Intranet database. An ET method of transfer would then take place.

FTD Method

A form is filled out on an Internet web page and the data is destined for an Intranet database. The data is entered into an Internet database and an entry is made in the WUT. An FTD method of transfer would then take place.

Delete

ET Method

A user requests to delete a record on the Internet database. The code of the page will execute a delete query to delete that record from the Internet database. An ET method of transfer would then take place.

FTD Method

A user requests to delete a record on the Internet database. The code of the page will execute a delete query to delete that record from the Internet database and it will write an entry in the WUT. An FTD method of transfer would then take place.

Send Data/Action From an Intranet Database to an Internet Database

Insert/Update/Delete

Data is inserted, updated in the Intranet database or deleted from the Intranet database and the action needs to be replicated at least in part on the Internet database. The code that made the change to the Intranet database would also write an appropriate entry in the Intranet databases WUT. An FTU method of transfer would then take place.

Send Data/Action From an Intranet Database to Another Intranet Database

Insert/Update/Delete

Data is inserted, updated in the Intranet database or deleted from the Intranet database and the action needs to be replicated at least in part on another Intranet database. The code that made the change to the Intranet database would also write an appropriate entry in the Intranet databases WUT. An ET method of transfer would then take place.

Table Rebuild

If the data in a particular table in an Internet database has many records out of synchronization with the corresponding table in an Intranet database, the table could be entirely rebuilt using the FTU method. Code on the Internet web site (usually the RTP) would execute a Delete query on the table in need of rebuilding, which would delete every record but leave the table intact. The code would then redirect to a page on the Intranet (usually the LTP), which would execute an Insert query that would write a record in the WUT for each record in the Intranet table. An FTU method of transfer would then take place, rebuilding the entire table.

What is claimed:

1. A method for transferring data information from a first data storage device operatively linked to a wide area network (WAN) via a computer to a physically remote second data storage device that may not be continuously linked to the WAN via a computer, the method comprising:
a) polling form-based or database information from the first data storage device;
b) creating an email-based file having the polled information present therein;
c) sending the email-based file having the information therein to a computer adapted to receive the email-based file;
d) retrieving the email-based file;
e) parsing the information from the email-based file; and
f) storing the parsed information in a physical location remote from the first server.

2. A method for transferring data information from a first data storage device operatively linked to a wide area network (WAN) via a computer to a physically remote second data storage device that may not be continuously linked to the WAN via a computer, the method comprising:
a) querying a table containing data residing in the first storage device;
b) polling the first storage device for the data;
c) compiling the polled data into a formatted data file;
d) submitting the formatted data file to the second storage device;
e) parsing the data; and
f) storing the parsed data in the second storage device.
